(19) United States
(12) Patent Application Publication
(10) Pub. No.: US 2026/0311447 A1
(43) Pub. Date: Oct. 8, 2026

(54) Method and System for Programmatic Video Prediction Using Large Language Models

(71) Applicant: Mitsubishi Electric Research Laboratories, Inc., Cambridge, MA (US)

(72) Inventors: Moitreya Chatterjee, Cambridge, MA (US); Hao Tang, Ithaca, NY (US); Suhas Lohit, Cambridge, MA (US); Michael Jones, Cambridge, MA (US)

(73) Assignee: Mitsubishi Electric Research Laboratories, Inc., Cambridge, MA (US)

(21) Appl. No.: 19/273,316

(22) Filed: Jul. 18, 2025

Related U.S. Application Data
(60) Provisional application No. 63/782,989, filed on Apr. 3, 2025.

(51) Int. Cl. G06V 10/44; G06T 7/12

(52) U.S. Cl. CPC G06V 10/44; G06T 7/12; G06V 2201/07

(57) ABSTRACT

Embodiments of present disclosure provide a method for video frame prediction. The method includes receiving a plurality of video frames representing an initial portion of a scene. A foundation model is used for generating a perception program to extract symbolic, human-interpretable, physics-grounded attributes from each of the received video frames. Further, the foundation model is used for generating a dynamics program that models the temporal evolution of the extracted attributes based on physical principles. The foundation model also generates a rendering program that maps future attribute states to predicted video frames. The perception program is then executed to extract latent state representations from the initial video frames. The dynamics program is applied to the extracted latent state representations to generate predicted latent states corresponding to future time steps. The rendering program is also executed to convert the predicted latent states into future video frames.

### TECHNOLOGICAL FIELD

The present disclosure relates generally to video frame prediction, and more particularly to video frame prediction using a foundation model.

### BACKGROUND

The ability to predict the future dynamics of a scene from visual data is a foundational challenge in artificial intelligence. It lies at the heart of applications such as autonomous driving, robotics, surveillance, and human-computer interaction. Traditionally, this task involves extrapolating the future states of a system based on a limited set of observed frames, demanding an understanding of both the physical laws that govern object behavior and the semantic relationships among those objects. While existing deep learning methods provide solutions for modeling video frame sequences with neural networks, these methods typically require massive training datasets, suffer from poor generalization to new environments, and provide limited interpretability into their predictions.

As artificial intelligence systems become ubiquitous and get deployed to work side-by-side with humans, for tasks such as video surveillance, autonomous driving, robotics, etc., it becomes increasingly important that they be capable of reasoning about the dynamics of real-world phenomena, given a visual context, and synthesize plausible futures.

Some solutions for the task of future video frames prediction provide end-to-end model architectures, typically based on deep-learning. Such models include diffusion-based models and other models based on an encoder-decoder architecture. These solutions suffer from the limitations of their reliance on copious amounts of training data and their lack of interpretability. Moreover, such solutions are only effective when the data on which the inference is to be performed is largely similar to the one on which they have been trained, which is unrealistic in many applications of video frame prediction technology.

Some methodologies for video frame prediction, model the dynamics of a real-world process using physics-based principles. These approaches seek to either estimate the physical properties of the objects that are present in the video, such as their mass, position, etc. by leveraging automated perception mechanisms or by having users provide initialization of those attributes and then often leverage a pre-defined dynamics model to explain the motion, given these attributes. While such methodologies address the lack of interpretability of end-to-end approaches, they either pre-define the set of physical attributes that are of interest or pre-define the world model governing the dynamics of the objects in the video, or both, thereby limiting their applicability.

Therefore, there exists a need for improved solutions for video frame prediction technologies for use in several video based applications, which are able to overcome all of the challenges discussed above.

### SUMMARY

Some embodiments are based on a recognition that the challenges of existing video frame prediction models may be overcome by developing a novel, physics-grounded, neuro-symbolic, program synthesis-based video prediction model that leverages the inductive biases of Large Language/Vision-Language Models (LLM/VLM) for improved training sample efficiency, generalizability, and interpretability.

Accordingly, some embodiments disclose user-guided editability and counter-factual reasoning on the video frames which are to be generated as well. To that end, some embodiments provide systems and methods that represent the dynamics of a video using a set of neuro-symbolic states, each defined by a set of human-interpretable, physics-grounded attributes, such as position or velocity of an object in the video.

Some embodiments provide such methods and systems that provide a programmatic perception pipeline to estimate these states from the visual context of a video and another program to learn the dynamics so as to be able to extend the state estimates into the future, using a VLM. A programmatic rendering pipeline also generated by a VLM, then enables ProgGen, the proposed method, to decode these states into visually plausible RGB-frames.

Some embodiments further disclose the use of a pre-trained deep-neural segmentation and tracking model (such as the Grounded-Segment Anything model) to facilitate the perception process needed to estimate the states and adopt a symbolic, physical simulator to simulate the objects' dynamics in the pixel space.

Some embodiments are based on a recognition that the human-interpretable nature of the estimated latent states lends them to human manipulation allowing for editing or counter-factual reasoning on the videos. To that end, some embodiments disclose systems and methods to predict the future RGB-frames of a video given an initial set of frames which set the context for the generation.

Some embodiments are based on a realization that some approaches for the video frame prediction task, that exist, either: (i) leverage an end-to-end deep learning-based approach, often using a diffusion-model based pipeline; or (ii) are physics-based, often relying on a pre-defined set of physical attributes or a pre-defined world model to characterize the motion. However, the former set of approaches need copious amounts of in-domain data for training and are not interpretable. On the other hand, the latter set of approaches, while being interpretable, are restrictive since they can only work in environments where a pre-defined set of attributes and/or a pre-defined dynamics model is used to characterize the environment in which it is being employed.

Some embodiments disclose methods and systems that address the afore-mentioned shortcomings by leveraging the inductive biases of LLM/VLM in order to do away with the need for large-scale training data. Further, some embodiments disclose methods and systems to undertake the forecasting in any settings without the need to pre-define the nature of dynamics or the physical attributes of interest.

Some embodiments disclose methods and systems to undertake the video prediction task by representing the dynamics of the video using a set of neuro-symbolic, human-interpretable set of states, thus allowing interpretability of the prediction process.

Some embodiments disclose methods and systems to permit counter-factual reasoning, editability, and interpretable video prediction.

Some embodiments are based on a recognition that the core difficulty in video prediction is not merely about learning pixel transitions but about modeling the world dynamics underlying those pixels. These dynamics often follow consistent physical laws that humans intuitively understand and can express in symbolic or mathematical forms. However, most deep models learn such regularities only implicitly, making them data-hungry and difficult to adapt to new tasks. Moreover, the internal representations of these models are opaque, offering little explanation for why a particular prediction was made or how it might change under hypothetical scenarios.

Accordingly, some embodiments disclose a method for video frame prediction. The method includes receiving a plurality of video frames representing an initial portion of a scene. The method further includes generating, via a foundation model, a perception program configured to extract symbolic, human-interpretable, physics-grounded attributes from each of the plurality of the received video frames. The method includes generating, via the foundation model, a dynamics program that models the temporal evolution of the extracted attributes based on physical principles. Moreover, the method also includes generating, via the foundation model, a rendering program that maps future attribute states to predicted video frames. Additionally, the method includes executing the perception program to extract latent state representations from the initial video frames, wherein the latent state representations are derived on the basis of a set of symbolic, human-interpretable, physics-grounded attributes associated with each of the plurality of video frames. The method also includes applying the dynamics program to the latent state representations to generate predicted latent states corresponding to future time steps. Additionally, the method includes executing the rendering program to transform the predicted latent states into future video frames to perform the video frame prediction. The perception program, dynamics program, and rendering program are each synthesized in a programmatic, human-interpretable format, and the latent state representations comprise physics-grounded variables including at least one of position, velocity, mass, angle, or force.

Accordingly, some embodiments disclose a system for video frame prediction. The system includes a processor and a memory having instructions stored thereon that, when executed by the processor, cause the system to: receive a plurality of video frames representing an initial portion of a scene. The system is also caused to generate, via a foundation model, a perception program configured to extract symbolic, human-interpretable, physics-grounded attributes from each of the received video frames. The system is also caused to generate, via the foundation model, a dynamics program that models the temporal evolution of the extracted attributes based on physical principles. The system is also caused to generate, via the foundation model, a rendering program that maps future attribute states to predicted video frames. The system is also caused to execute the perception program to extract latent state representations from the initial video frames, wherein the latent state representations are derived on the basis of the symbolic, human-interpretable, physics-grounded attributes associated with each of the plurality of video frames. The system is also caused to apply the dynamics program to the latent state representations to generate predicted latent states corresponding to future time steps. The system is also caused to execute the rendering program to convert the predicted latent states into future video frames. The perception program, dynamics program, and rendering program are each synthesized in a programmatic, human-interpretable format, and the latent state representations comprise physics-grounded variables including at least one of position, velocity, mass, angle, or force.

### BRIEF DESCRIPTION OF THE DRAWINGS

The presently disclosed embodiments will be further explained with reference to the following drawings. The drawings shown are not necessarily to scale, with emphasis generally being placed upon illustrating the principles of the presently disclosed embodiments.

FIG. 1 illustrates a schematic diagram of a method for video frame prediction, according to an embodiment of the present disclosure.

FIG. 2 illustrates an example block diagram of a system for video frame prediction, in accordance with an embodiment of the present disclosure.

FIG. 3A illustrates a schematic diagram of a perception program, in accordance with an embodiment of the present disclosure.

FIG. 3B illustrates a schematic diagram of latent space representations extracted by the perception program, according to an embodiment of the present disclosure.

FIG. 4A illustrates a schematic diagram of a dynamics program, in accordance with an embodiment of the present disclosure.

FIG. 4B illustrates a schematic diagram of future states prediction performed by the system of FIG. 2, in accordance with an embodiment of the present disclosure.

FIG. 5 illustrates a schematic diagram of a rendering program, in accordance with an embodiment of the present disclosure.

FIG. 6 illustrates a schematic diagram showing training of the system, according to an embodiment of the present disclosure.

FIG. 7 illustrates a schematic diagram of an algorithm executed by the system of FIG. 2 during inference, in accordance with an embodiment of the present disclosure.

FIG. 8 illustrates a schematic diagram showing a qualitative visualization for frames predicted by the system for the out of domain two ball collision case, according to an embodiment of the present disclosure.

FIG. 9 illustrates a schematic diagram of an example implementation of the system of FIG. 2 for the cart pole problem scenario, in accordance with an embodiment of the present disclosure;

FIG. 10 illustrates a schematic diagram of a user interface for the system of FIG. 2, in accordance with an embodiment of the present disclosure.

FIG. 11 illustrates a schematic diagram of another user interface for the system of FIG. 2, in accordance with an embodiment of the present disclosure.

FIG. 12 illustrates a representative computing device suitable for implementing the system shown in FIG. 1 and its associated processes and modules, according to an embodiment of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Some embodiments disclose a physics-grounded, neuro-symbolic, and program synthesis-based framework for video prediction. To that end, some embodiments disclose a video prediction system configured to represent the dynamics of a scene through programs that are human-readable and physically meaningful. These programs are not static or pre-specified, instead, they are synthesized dynamically using the inductive capabilities of large language models (LLMs) and vision-language models (VLMs).

Some embodiments disclose systems and methods that disclose generation of three interconnected programs: one for visual perception, one for modeling the dynamics, and one for rendering predicted frames. These programs operate over neuro-symbolic states—interpretable representations that describe attributes of objects in the scene like their position, velocity, and orientation.

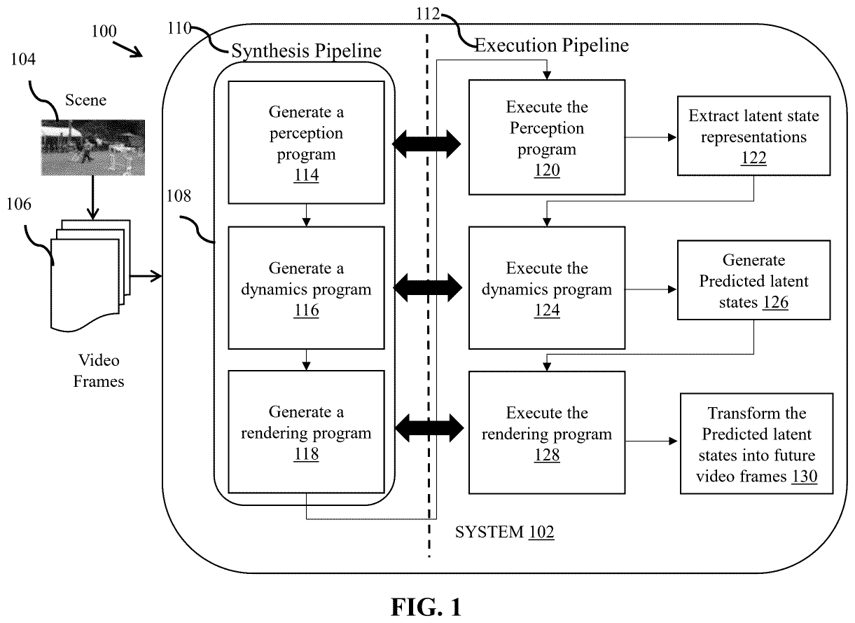

FIG. 1 illustrates a schematic diagram of a method 100 for video frame prediction, according to an embodiment of the present disclosure. The method 100 may be implemented by a system 102, such as a computing device such as a computer, a processor, a mobile device, a server computer, and the like.

The method 100 is used to perform video frame prediction using a programmatic pipeline. The programmatic pipeline in turn includes two distinct operation pipelines—a synthesis pipeline 110 and an execution pipeline. The method 100 begins with receiving a plurality of video frames 106 representing an initial portion of a scene 104. The scene 104 may correspond to a real-time sensor captured feed from an environment, an artificially generated or synthesized video, stored video content, recorded video, and the like.

In some embodiments, the scene 104 is converted to the plurality of video frames 106 by processing it temporally and converting it into a sequence of visual images at discrete time steps. This applies to both real-world (camera-based) and synthetic (rendered or simulated) video. The conversion may be performed by a processing module (not shown in the figure) that extracts a scene representation and converts the scene representation (such as in terms of objects, motion data, object lighting etc.,) into a scene state representation. Further, a sampler may sample the scene state at different time steps, which is then used by a frame generator to generate the plurality of video frames 106 corresponding to the scene 104.

To that end, the scene 104 may be represented by a video representation, V={f₀, f₁, f₂, . . . , f_{T}} with T+1 frames, denoting the plurality of video frames 106. The plurality of video frames 106, {f₀, f₁, f₂, . . . , f_{T}}, may be thought of as a collection of T+1 random variables fᵢ, each denoting an RGB frame of the video, i.e. fᵢ∈ [symbol] , where H and W denote the height and width of each frame. Given a set of F+1 initial frames of the video (0≤F<T), to set the visual context, the task of video frame prediction entails forecasting the remaining frames, f_{F+1} onwards through f_{T}. Addressing this task requires designing a model p_{θ}, parameterized by a set of parameters θ, which takes as input the first F+1 frames of an unseen video and predicts the remaining frames. This can be represented as:

$${\{ {f}_{i} \}}_{i = F + 1}^{T} = {p}_{θ} ( {\{ {f}_{j} \}}_{j = 0}^{F} ; {\{ {ψ}_{j} \}}_{j = 0}^{F} ) ,$$

where ψⱼ denotes a possible latent state of the model (one for every predicted frame).

In some embodiments, the model p_{θ} may be encapsulated by the system 102 and may correspond to a foundation model 108, which is configured for performing the operations corresponding to the synthesis pipeline 110. The foundation model 108 may be a large language model (LLM), a vision language model (VLM), or a combination thereof of both the LLM and the VLM.

In some embodiments, the foundation model 108 may be pre-trained on broad, heterogeneous datasets using self-supervised or unsupervised learning objectives. The foundation model 108 may be configured to generate general-purpose representations, or latent state representations, which are transferable across a plurality of downstream tasks. In some embodiments, the foundation model 108 may be implemented using a transformer-based architecture and is operable across one or more modalities, including but not limited to text, images, video, and audio. Following pretraining, the foundation model 108 may be adapted via fine-tuning, prompting, or in-context learning to perform specific tasks such as natural language generation, image classification, object detection, video understanding, or multimodal reasoning. In some instances, the foundation model is further configured to operate in zero-shot or few-shot settings, wherein it performs target tasks with little to no task-specific supervision.

The foundation model 108 is configured to perform the operations corresponding to the synthesis pipeline 110, which include, at 114, an operation for generating a perception program. The perception program is configured to extract symbolic, human-interpretable, physics-grounded attributes from each of the plurality of the received video frames 106.

The synthesis pipeline 110 further includes, at 116, an operation for generating, via the foundation model 108, a dynamics program that models the temporal evolution of the extracted symbolic, human-interpretable, physics-grounded attributes based on physical principles. The physical principles include laws of physics governing at least one motion, appearance, or position of an object in the scene 104.

The synthesis pipeline 110 further includes, at 118, an operation for generating, via the foundation model 108, a rendering program that maps future attribute states to the predicted video frames corresponding to the scene 104.

It may be understood that the operations 114-118 may be executed sequentially, in parallel, or in any order, without limiting the scope of the present disclosure.

After the operations of the synthesis pipeline 110 are performed, the method 100 further includes operations corresponding to the execution pipeline 112. The operations of the execution pipeline include, at 120, an operation comprising executing the generated perception program to, at 122, perform an operation to extract latent state representations from the initial video frames corresponding to the plurality of video frames 106. For example, the first F+1 frames may be the initial video frames corresponding to the plurality of video frames 106. The execution pipeline 112 further includes, at 124, an operation comprising executing the generated dynamics program 124 to apply the dynamics program to the extracted latent state representations to, at 126, perform an operation to generate predicted latent states corresponding to future time steps. To that end, the predicted latent states correspond to predicted video frames at future time steps. The method 100 then includes, at 128, performing an operation to execute the rendering program to transform the predicted latent states into the future video frames to perform the video frame prediction.

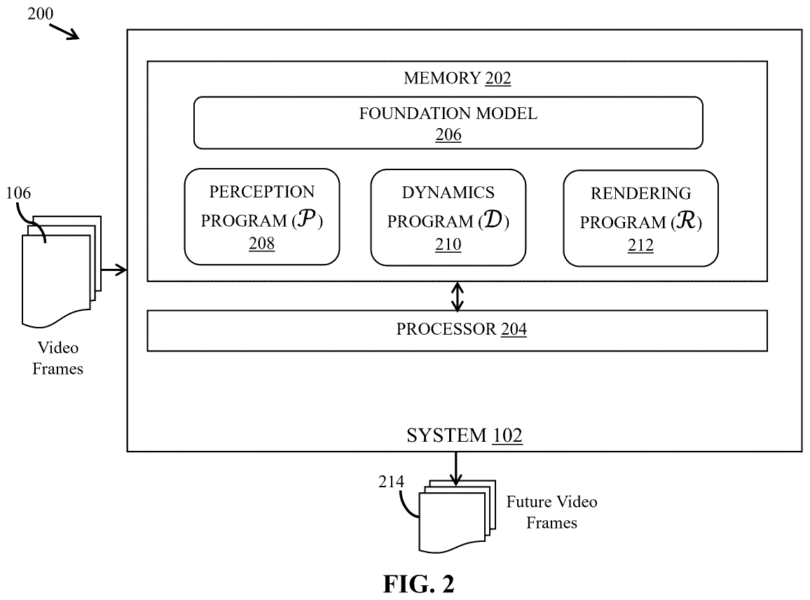

In some embodiments, each of the perception program, the dynamics program, and the rendering program are each synthesized during the synthesis pipeline 110 in a programmatic, human-interpretable format, and the extracted latent state representations comprise physics-grounded variables including at least one of position, velocity, mass, angle, or force. The various components of the system 102 and the method 100 are further explained in conjunction with FIG. 2.

FIG. 2 illustrates an example block diagram 200 of the system 102 for video frame prediction, in accordance with an embodiment of the present disclosure. FIG. 2 is explained in conjunction with elements from FIG. 1. The system 102 includes a memory 202 and a processor 204.

In some embodiments, the processor 204 includes one or more processors configured to execute instructions stored in the memory 202 to perform the functionalities described herein. The processor(s) 204 may include a central processing unit (CPU), a graphics processing unit (GPU), a digital signal processor (DSP), a tensor processing unit (TPU), a neural processing unit (NPU), a field-programmable gate array (FPGA), an application-specific integrated circuit (ASIC), or any combination thereof. In some embodiments, the processor 204 is configured to execute operations associated with artificial intelligence models, such as machine learning models, a foundation model 206 (equivalent to the foundation model 108), neural networks, or vision-language models, including but not limited to model inference, data preprocessing, and post-processing. The processor 204 may also be configured to coordinate communication between system components, manage memory access, and perform control logic and decision-making functions. The processor 204 may be implemented as a single processing unit or distributed across multiple processors operating in parallel or in a networked configuration.

In some embodiments, the memory 202 includes one or more memory devices (e.g., memory, data storage, or computer-readable storage media) configured to store instructions that, when executed by one or more processors, such as the processor 204, cause the system 102 to perform the operations described herein. The memory 202 may include volatile memory (e.g., random-access memory (RAM)) and/or non-volatile memory (e.g., read-only memory (ROM), flash memory, solid-state drives (SSDs), magnetic storage, or other persistent storage). In some embodiments, the memory 202 stores data structures, models, intermediate computations, and program logic, including code implementing one or more artificial intelligence modules, such as machine learning models, neural networks, or vision-language models. The memory 202 may be implemented as a single device or distributed across multiple physical storage units and may be local to the processing system or remotely accessible over a network. The memory 202 stores at least a foundation model 206, a perception program 208, a dynamics program 210, and a rendering program 212.

The foundation model 206 is equivalent to the foundation model 108 described in conjunction with FIG. 1. To that end, the foundation model 206 may include code or computer-executable instructions to enable implementation of the synthesis pipeline 110 of the method 100.

In some embodiments, the foundation model 206 includes an LLM. In some embodiments, the foundation model 206 includes a VLM.

In some embodiments, the foundation model 206 is a Large VLM, like GPT-4. As used herein, a foundation model refers to a large-scale machine learning model trained on extensive and diverse datasets using general-purpose learning objectives (e.g., self-supervised learning), and which is designed to be adaptable to a wide range of downstream tasks with minimal task-specific supervision. Foundation models are typically implemented using deep neural network architectures, such as transformers, and may operate across one or more modalities, including text, image, audio, and video. Such models are characterized by their ability to generalize, transfer knowledge, and perform tasks in zero-shot or few-shot settings.

In one embodiment, the foundation model 206 may be implemented as a large visual language model (LVLM), such as GPT-4, which integrates vision and language understanding in a unified architecture. The foundation model 206 is pre-trained on a combined corpus of textual and visual data to learn aligned multimodal representations. As such, it is capable of performing diverse tasks including natural language generation, image captioning, visual question answering, diagram interpretation, video frame prediction, and multimodal reasoning. For example, the foundation model 206 may receive an image and a natural language prompt and generate a descriptive or analytical response based on the visual content of the image and the semantic context of the prompt. The ability of the foundation model 206 to reason over visual and linguistic inputs in a coherent, context-sensitive manner enables its application in domains such as autonomous systems, human-computer interaction, document analysis, augmented reality, and multimodal search and retrieval.

In the embodiment described herein, the foundation model 206 receives the plurality of video frames 106 representing an initial portion of the scene 106 and causes the processor 204 to execute instructions to process the received plurality of video frames 106 and generate at least three different programs—a perception program 208, a dynamics program 210, and a rendering program 212. The perception program 208 is generated, for example, by the operation at step 114 of the method 100. The dynamics program 210 is generated, for example, by the operation at step 116 of the method 100. The rendering program 212 is generated, for example, by the operation at step 118 of the method 100.

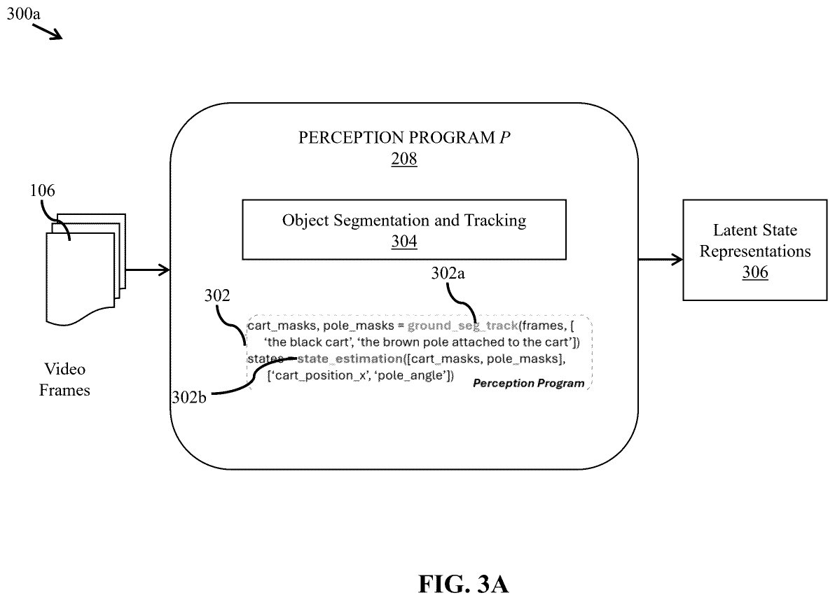

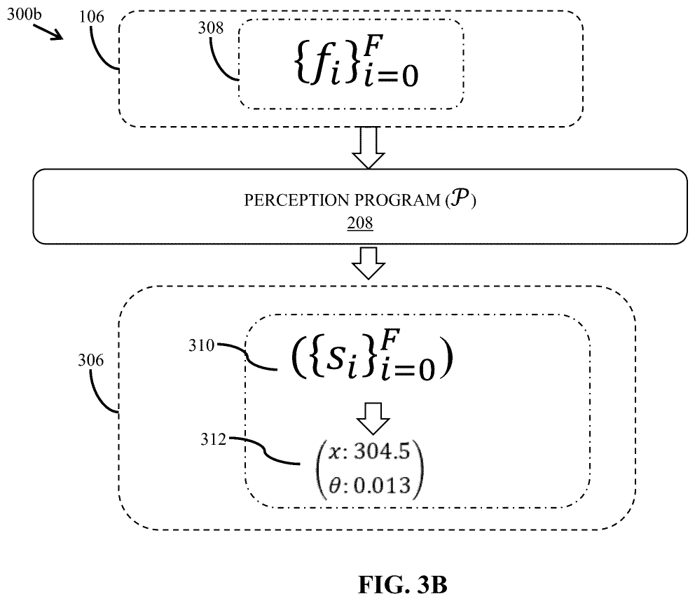

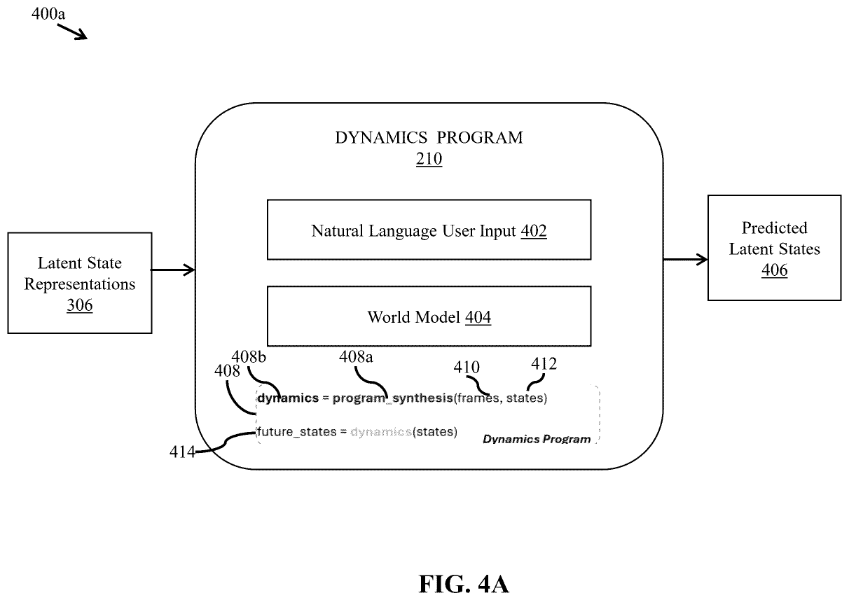

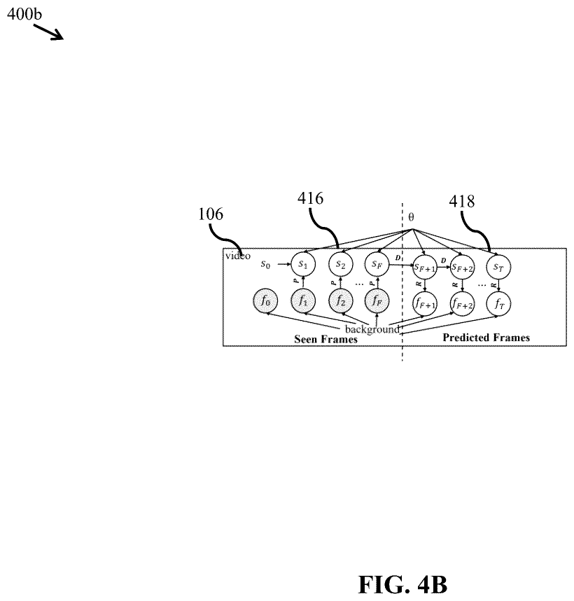

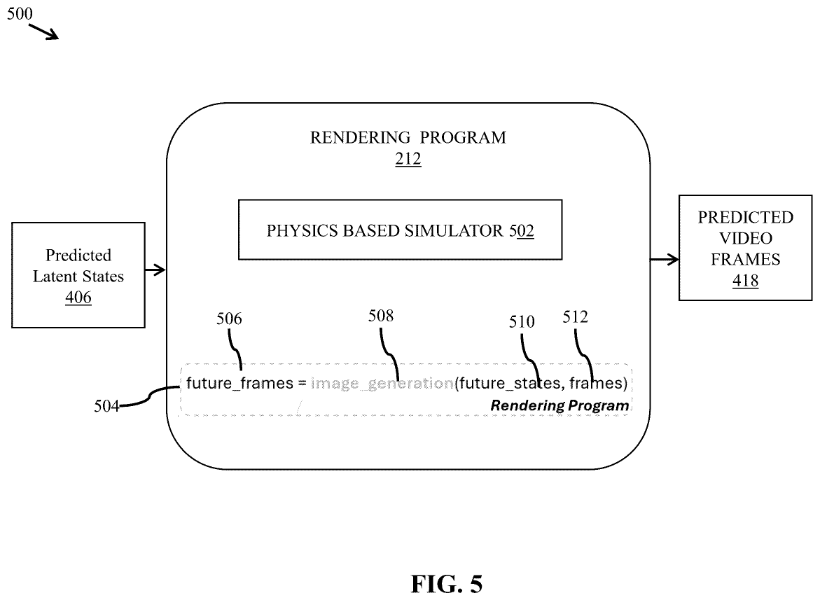

To that end, each of the at least three different programs are synthesized by the foundation model 206 in a programmable, human-interpretable format. For example, each of the perception program 208, the dynamics program 210, and the rendering program 212, are Python programs in an embodiment. The format of each of the at least three different programs will be described at least in FIG. 3A, FIG. 4A, and FIG. 5.

The functionality of the system 102 that includes generation of the three programs—the perception program 208, the dynamics program 210, and the rendering program 212 provides capability in video processing applications for modeling the world dynamics underlying the pixels of video frames. These world dynamics often follow consistent physical laws—laws that humans intuitively understand and can express in symbolic or mathematical forms. However, most deep models learn such regularities only implicitly, making them data-hungry and difficult to adapt to new tasks. Moreover, the internal representations of these models are opaque, offering little explanation for why a particular prediction was made or how it might change under hypothetical scenarios.

Instead, the system 102 provides a physics-grounded, neuro-symbolic, and program synthesis-based framework for video prediction. The system 102 provides analysis of the dynamics of a scene, such as the scene 104, through programs—that is, the perception program 208, the dynamics program 210, and the rendering program 212, that are human-readable and physically meaningful. These programs are not static or pre-specified; instead, they are synthesized dynamically using the inductive capabilities of large language models (LLMs) and vision-language models (VLMs). Given a short initial video sequence, the system 102 builds three interconnected programs: one for visual perception (the perception program 208), one for modeling the world dynamics (the dynamics program 210), and one for rendering predicted frames (the rendering program 212). These programs operate over neuro-symbolic states—interpretable representations that describe attributes like object position, velocity, and orientation.

The system 102 is configured via the processor 204 to also execute each of the at least three synthesized programs to cause generation of future video frames 214 for the scene 104. In an example, the plurality of video frames 106 corresponding to the initial portion of the scene 104 are represented as {f₀, f₁, f₂, . . . , f_{F}}. The foundation model 206 is represented as p_{θ} which is configured to synthesize the perception program 208, [symbol] ; the dynamics program 210, [symbol] ; and the rendering program 212, [symbol] . Upon execution of the synthesized perception program 208, [symbol] ; the dynamics program 210, [symbol] ; and the rendering program 212, [symbol] by the processor 204, the system 102 is caused to predict and/or generate the future video frames 214, which are represented as frames, f_{F+1} onwards through f_{T}. To that end, the foundation model p_{θ}, parameterized by a set of parameters θ, takes as input the first F+1 frames of the (unseen) video of the scene 104 and predicts the remaining frames as defined by the equation

$${\{ {f}_{i} \}}_{i = F + 1}^{T} = {p}_{θ} ( {\{ {f}_{j} \}}_{j = 0}^{F} ; {\{ {ψ}_{j} \}}_{j = 0}^{F} ) ,$$

disclosed earlier in FIG. 1.

Each of the synthesized three programs and working of the system 102 will be described further in the following figures and their accompanying description.

FIG. 3A illustrates a schematic diagram 300a showing the perception program 208, in accordance with an embodiment of the present disclosure. FIG. 3A is explained in conjunction with elements from FIG. 1 and FIG. 2.

In some embodiments, the perception program 208 is configured to extract symbolic, human-interpretable, physics-grounded attributes from each of the plurality of received video frames 106. In some embodiments, the perception program 208 includes human-interpretable and meaningful code written in a known programming language, such as Python. Code snippet 302 gives an example snippet or portion on the perception program 208 generated by the system 102 using the foundation model 206. The code snippet 302 includes functions such as, names ground_seg_track 302a and state_estimation 302b. The ground_seg_track 302a function defines functionality for segmentation and tracking of objects in the plurality of video frames 106. The state_estimation 302b function defines functionality for estimating physical states (like position and angle) from the segmented object masks.

To that end, the perception program 208 utilizes a pre-trained object segmentation or tracking model 304 to identify objects within the plurality of video frames 106. In an example, the perception program 208 identifies and tracks key objects across video frames using state-of-the-art object segmentation and tracking model(s) 304, such as Grounded-SAM and XMem. In an embodiment, Grounded-SAM is used for detecting and localizing the objects in the plurality of video frames 106 and XMem is used for ensuring that the detections are consistent over the plurality of video frames 106.

Further, the perception program 208 encodes the segmented objects into neuro-symbolic states, capturing relevant physical quantities. The neuro-symbolic states are transformed into latent state representations 306 which are extracted as a result of the synthesis and execution of the perception program 208 [symbol] , by the processor 204. The latent-state representations 306 are derived on the basis of symbolic, human-interpretable, physics-grounded attributes associated with each of the plurality of video frames 106. For example, these symbolic, human-interpretable, physics-grounded attributes may include the position of an object, the velocity of the object, the orientation of the object, and the like. The extraction of the latent space representations 306 by the perception program 208 on the basis of the symbolic, human-interpretable, physics-grounded attributes is illustrated, for example, in FIG. 3B.

FIG. 3B illustrates a schematic diagram 300b of latent space representations 306 extracted by the perception program 208, according to an embodiment of the present disclosure.

The perception program 208, [symbol] , maps each RGB-frame 308

$${\{ {f}_{i} \}}_{i = 0}^{F}$$

from the plurality of video frames 106 to a state

$$( {\{ {s}_{i} \}}_{i = 0}^{F} )$$

310 in the latent state representations 306. Each state 310 is a collection of symbolic, human-interpretable, physics-grounded attributes 312, such as position x of an object, angle Θ between the object's parts, and the like. To that end, the perception program 208 automatically determines which attributes are the most applicable for the type of video defined by the plurality of video frames 106 of the scene 104.

Some embodiments include the perception program 208 being used for video prediction by transforming the latent space representations 306 in a manner that preserves the laws of physics. Some video prediction systems operate at the pixel level, where models attempt to extrapolate future frames based on dense visual data. While effective in terms of visual fidelity, such video prediction systems fail to provide interpretability or composability and are unable to provide generalization beyond the training distribution. However, the system 102 is able to perform such generalization and explainability by not basing predictions in the pixel space, but in a structured latent space formed by the latent space representations 306 where variables of the latent space correspond to meaningful physical quantities defined by the symbolic, human-interpretable, physics-grounded attributes 312, such as position, velocity, orientation, and mass.

In this context, the latent space comprises compact, semantically rich latent state representations 306 of the plurality of video frames 106, where each object in the scene 304 is encoded using the symbolic, human-interpretable, physics-grounded attributes 312. Rather than learning transformations of raw pixel intensities, the system 102 learns transformations of these symbolic, human-interpretable, physics-grounded attributes 312 based latent space representations 306 according to physical rules. The latent space representations 306 serve as a high-level abstraction over the visual world, providing a structured canvas upon which physical reasoning can thus operate. Unlike conventional encoder-decoder based approaches, the latent states representations 306 Si, are symbolic, human-interpretable, and carry semantic meaning.

In some embodiments, the design of the system 102 allows for the perception program 208 [symbol] to figure out what attributes might be the most fitting to represent the latent state representations 306. Such a capability allows for much more flexibility of representation, thereby enhancing the generalizability of the overall system 102.

In some embodiments, perception program 208 [symbol] declares the discrete structure of the scene 104 by defining, such as how many objects there are in the scene 104, if two objects are connected, if an object is dynamic or static, and the like. Further, the latent space is structured such that transformations of latent states preserve physical consistency across time steps of the scene 104.

Transformations in the latent space take the form of dynamics functions that evolve object states over time. These transformations are learned directly from data, rather than being hard-coded. Crucially, they are constrained to follow the physical principles observable in the training data. For example, if an object is moving at a constant speed, the system 102 learns to represent this motion as a rule of inertia—a fundamental physical law—in the latent space. This ensures that predictions are not only accurate but also physically plausible.

In an example, for a simple scenario involving a ball moving horizontally and eventually bouncing off a wall, the input to the system 102 is a sequence of three frames, each showing the ball at a slightly different position. The perception program 208 extracts latent state representations 306 from each frame, identifying the ball's position x and estimating its velocity v based on the change in position over time. This leads to a latent state representation such as:

$${s}_{t} = \{ position : {x}_{t} , velocity : {v}_{t} \}$$

The evolution of the latent state representations 306 is defined by the dynamics program 210 which is explained in the following figure.

FIG. 4A illustrates a schematic diagram 400a of the dynamics program 210 and its functionality, in accordance with an embodiment of the present disclosure. FIG. 4A is explained in conjunction with FIG. 1, FIG. 2, FIG. 3A, and FIG. 3B.

The dynamics program 210 is based on a recognition that the task of extrapolating the dynamics of a real world process into the future is an essential one and necessitates an understanding of a world model 404 governing the dynamics of the process. This world model is not limited to be of any particular kind. In an example, this could be the laws of inertia. To that end, the dynamics program 210, [symbol] , is configured to learn the dynamics of the world using this world model 404 so as to be able to extend the state estimates into the future, using a VLM, such as the VLM used in the foundation model 206. Thus, the dynamics program 210 [symbol] forecasts or predicts future physics-grounded states, referred to as predicted latent states 406 given a past set of states, such as the latent state representations 306, extracted using the perception program 208 shown in FIG. 3A. Likewise, the dynamics program 210 [symbol] and the latent state representations 306 allow for flexibility in representing the dynamics of a video, such as captured by the plurality of video frames 106, with the latent state representations 306 capturing the global parameters in an environment, in the form of the symbolic, human-interpretable, physics-grounded attributes 312, such as position, velocity, orientation, gravity, and mass.

In an embodiment, the dynamics program 210 includes human-interpretable and meaningful code written in a known programming language, such as Python. Code snippet 408 gives an example of the dynamics program 210 in an example. The code snippet 408 includes a program_synthesis function 408a, which is configured to learn or generate a model of a system's dynamics based on observations derived from the plurality of video frames 106 and state variables corresponding to the latent state representations 306. Thus, the program_synthesis function 408a synthesizes a program or function that captures how the system captured in the plurality of video frames 106 evolves over time and based on physics of the system. The program_synthesis function 408a takes as input a sequence of video frames 410 (images over time), such as the plurality of video frames 106; and states 412, such as the latent space representations 306. The dynamics program 210 also includes a dynamics model 408b which is a synthesized function or model that, when given the current state, can predict the next state of the system. To that end, the code snippet 408 dubs the output of the program_synthesis function as future_states variable 414 defined as future_states=dynamics (states). The estimated function dynamics are used to compute the next state for the latent state representations 306. Thus, the output of the future_states variable 414 are the predicted next states, such as the predicted latent states 406. The predicted latent states 406 are equivalent to the predicted latent states generated at 126 operation of the method 100 disclosed in FIG. 1. In an example, if states contain the cart position and pole angle, the predicated latent states 406 might output their future values after one time step.

To that end, the code snippet 408 illustrates that the dynamics program 210 is generated to include symbolic code that encodes physical laws, including but not limited to laws of inertia, conservation of momentum, or gravitational acceleration. In an example scenario with two balls colliding in a scene, the laws of conservation of momentum might be best suited to explain the dynamics.

In an embodiment, the dynamics program 210, given the object masks and the state representations corresponding to the plurality of input frames, estimates the future latent states 406 by modeling the temporal behavior (i.e., dynamics) of scene 104.

The temporal evolution of the latent space representations 306 as predicted by the dynamics program 210 is illustrated further in FIG. 4B.

FIG. 4B illustrates a schematic diagram 500b of future states prediction performed by the system 102 using the dynamics program 210, in accordance with an embodiment of the present disclosure.

The schematic diagram 400b is a plate diagram of the system 102 using the perception program 208, the dynamics program 210, and the rendering program 212. As shown in the plate diagram the video corresponding to plurality of frames 106 (also referred to interchangeably as the video 106 for the sake of brevity of disclosure) has each frame fᵢ of the video derived from its underlying latent state sᵢ, which in turn is influenced by the previous states s_{0:i-1}. Further for completeness, a random variable, background, is considered to be capturing the details of the static background environment of the video. A set of seen frames 416 which include first F+1 frames are used to set the visual conditioning, while subsequent frames are to be predicted in the form of predicted frames 418.

The previous states s_{0:i-1} describe the phenomena observed in the set of seen frames 416 f₀ through f_{F}. The states s_{F+1} to s_{T} associated with the set of predicted frames 418, f_{F+1} through f_{T}, maintain consistency with the set of seen frames 416 f₀ through f_{F}. Thus, the dynamics program 210 [symbol] generates the future physics-grounded states given a past set of states. Further, the rendering program 212 ( [symbol] ), maps these states

$$( {\{ {s}_{i} \}}_{i = F + 1}^{T} )$$

back to the RGB-frames. The inference pipeline of system 102 operates by having [symbol] derive the state-representation (or the latent state representations 306) of the set of seen frames 416 in the video 106

$$( {\{ {f}_{i} \}}_{i = 0}^{F} ) ,$$

followed by [symbol] forecasting the set of neuro-symbolic states corresponding to the unseen frames or the set of predicted frames 418

$$( {\{ {s}_{i} \}}_{i = F + 1}^{T} ) ,$$

given the state-representation of the seen frames in the video

$$( {\{ {s}_{i} \}}_{i = 0}^{F} ) .$$

Finally, [symbol] decodes the predicted latent states 406 of the set of predicted frames 418, in order to synthesize the predictions for the corresponding RGB-frames

$$( {\{ \hat{{f}_{i}} \}}_{i = F + 1}^{T} ) .$$

At a high-level the system 102, subsumes two tasks: (i) Video Understanding: this entails estimating the neuro-symbolic states, corresponding to the set of seen frames 416, f₀ through f_{F} of a video, using [symbol] , such that when these states are decoded into RGB-frames, using [symbol] , they maximize the likelihood of the set of seen frames 416; and (ii) Video Prediction: Wherein, [symbol] and a handful of trainable parameters θ, are used to learn the video dynamics, i.e. the world model, and forecast the predicted latent states 406 corresponding to the set of predicted frames 418, f_{F+1} through f_{T} of the video 106. This is followed by the use of [symbol] to decode these states to RGB-frames. During training, both the video understanding and video prediction steps can leverage all T+1 frames of a video in the training set to determine the [symbol] , [symbol] , θ, and [symbol] which best explain the said videos. For inference on any video, rather than directly predicting the unseen frames, f_{F+1:T}, given the seen frames f_{0:F}, as is common in conventional encoder-decoder based frame prediction approaches, [symbol] may be first used to encode the set of seen frames 416 into states, and then [symbol] , θ, and [symbol] , to predict and render the set of predicted frames 418.

In some embodiments, the perception step executed during execution of the perception program 208 can be represented by the following notation:

$${s}_{i} ∼ p ( \cdot \vert {f}_{i} ; 𝒫 ) ; ∀ i ∈ \{ 0 , … , F \}$$

While the prediction step executed during execution of the dynamics program 210 and rendering program 212 can be described, using the following two-step procedure:

$${s}_{i} ∼ h ( \cdot \vert {s}_{i - 1} ; 𝒟 , θ ) ; ∀ i ∈ \{ F + 1 , … , T \}$$

$${f}_{i} ∼ r ( \cdot \vert {s}_{i} ; ℛ ) ; ∀ i ∈ \{ F + 1 , … , T \}$$

To that end, the dynamics of the video 106 may be captured by the evolution of the states, following the rules specified by the dynamics program 210, [symbol] , and the global trainable parameters, θ. In particular, [symbol] lays out the laws of physics that principally explain the dynamics in the video 106, such as laws of inertia, laws of conservation of energy and momentum and the like.

In the manner described above, the dynamics program 210 models the temporal evolution of the extracted attributes defining the latent state representations 306 based on physical principles. Thus, the system 102 causes the processor 204 to execute the dynamics program 210 and apply the dynamics program 210 to the latent state representations 306 to generate the predicted latent states 406 corresponding to future time steps, such as the time steps F+1, . . . , T.

In some embodiments, the system 102 is configured to receive a user-specified modification to a latent state variable associated with the latent state representations 306. For example, referring to FIG. 4A, the dynamics program 210 may include instructions to process natural language user input 402, associated with modification or editing of a latent space variable. In an example, the natural language user input 402 is in the form of a natural language prompt, which is processed in conjunction with the foundation model 206. For example, a user may suggest a modification to a velocity variable associated with the plurality of video frames 106. To that end, the system 102 may include a user interface and a display to support the reception of the natural language user input 402 associated with the modification of the latent space variable associated with the latent space representations 306.

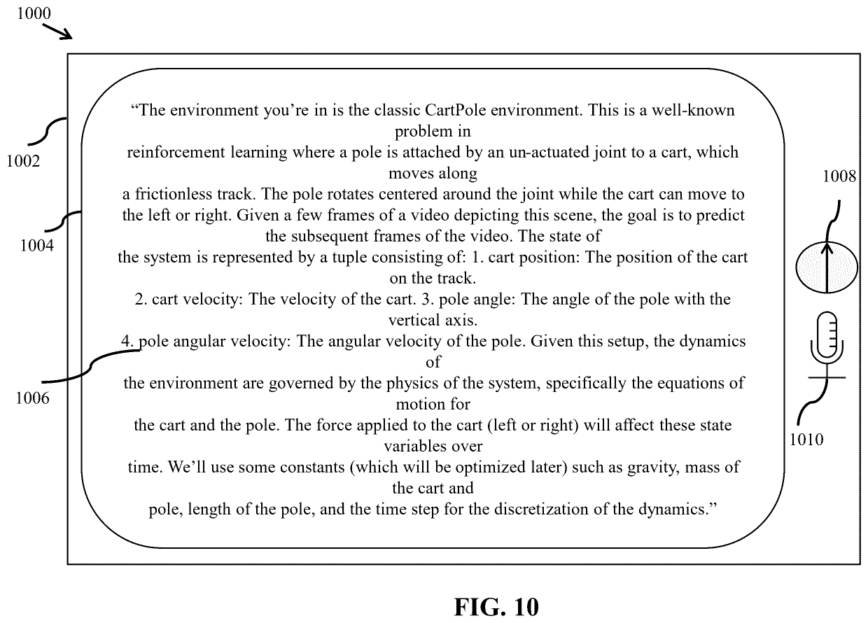

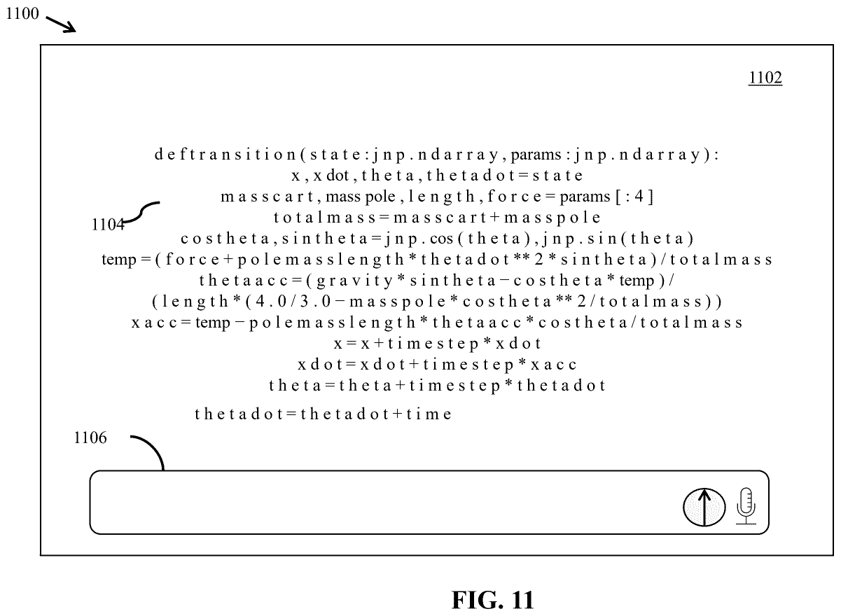

In some embodiments, the foundation model 206 is prompted with natural language instructions that describe the environment depicted in the plurality of video frames 106 to guide synthesis of the dynamics program 210. This will be explained further in conjunction with FIG. 10 and FIG. 11.

In some embodiments, application of the dynamics program 210 and the rendering program 212 configures the system 102 to generate a counterfactual video prediction corresponding to the user-specified modification to the latent state variable associated with the latent state representations 306.

In some embodiments, the system 102 is configured to learn a transformation function D such that sₜ₊₁=D(sₜ), where D encapsulates the rules governing the evolution of the latent state representations 306. In the case of constant velocity motion and an elastic collision with a wall, this learned rule might resemble:

$$if {x}_{t} < {x}_{wall} : {x}_{t + 1} = {x}_{t} + {v}_{t} \cdot Δ t$$

$$else : {v}_{t + 1} = - {v}_{t} , {x}_{t + 1} = {x}_{t} + {v}_{t + 1} \cdot Δ t$$

This transformation accurately captures both the principle of inertia and the rule of momentum conservation in a collision. Importantly, the rules are not fixed in advance. Instead, they are synthesized by a large language or vision-language model (LLM/VLM), which infers the most likely dynamics consistent with the observed states and applies them in a programmatic form.

In some embodiments, the dynamics program 212 includes symbolic code, such as the code snippet 408, that includes instructions for encoding physical laws, such as the law of inertia and momentum described above. The physical laws may also include but are not limited to laws of gravitational acceleration. For example, the cart pole, as will described later in the figures, addresses the laws of gravity and gravitational acceleration.

By modeling dynamics in this way, the system 102 achieves several important benefits. First, it dramatically reduces the data requirements for training since it relies on compact state transitions rather than high-dimensional pixel comparisons. Second, it enhances generalization, as the same learned rule can apply to different object configurations, scales, or velocities. Third, it enables interpretability: because the transformation rules are symbolic and physics-grounded, they can be inspected, modified, or explained in natural language. This opens the door to powerful capabilities such as counterfactual reasoning, where a user might change the initial velocity or mass of an object and observe how the prediction changes.

In some embodiments, the system 102 is able to generalize from very few training examples—as few as 10 videos—compared to the thousands or millions required by diffusion-based or transformer-based models. This is a direct consequence of incorporating inductive priors from LLMs and explicitly modeling physics through symbolic states. Additionally, the system 102 supports counterfactual reasoning: users can modify a symbolic state (e.g., increase the mass of an object or reverse the direction of motion), and the system 102 will generate a new sequence of plausible future frames or the set of predicted frames 418. This capacity for manipulation and understanding is critical in domains like robotics and safety-critical systems, where explainability and user control are essential. The generation of the set of predicted frames is performed by the rendering program 212, as will be described in FIG. 5 that follows.

FIG. 5 illustrates a schematic diagram 500 of the rendering program 212, in accordance with an embodiment of the present disclosure. FIG. 5 is explained in conjunction with elements from FIG. 1, FIG. 2, FIG. 3A, FIG. 3B, FIG. 4A, and FIG. 4B.

In some embodiments, the rendering program 212, [symbol] , is generated by the foundation model 206, such as the step 118 of the method 100 shown in FIG. 1. The rendering program 212 includes instructions that map future attribute states corresponding to the predicted latent states 406 to predicted video frames, such as the set of predicted video frames 418 (hereinafter the terms future video frames, precited video frames, and the set of predicted video frames will be used interchangeably to mean the same). When the rendering program 212 is executed, such as at step 128 in the execution pipeline 112 shown for the method 100 in FIG. 1, the rendering program 212 causes the processor 204 to transform the predicted latent states 406 into the future video frames to perform the video frame prediction by the system 102. Thus, the rendering program is configured to render the predicted latent states 406 as visual RGB-frames.

In some embodiments, the rendering program 212 is synthesized in a programmatic, human-interpretable format, such as using Python programming language. For example, a code snippet 504 shows a sample Python code used as the rendering program 212 in an embodiment. The code snippet 504 includes a future_frames variable 506. The future_frames variable 506 is derived from an image_generation function 508 that takes as input, a variable future_states 210. The variable future_states 210 corresponds to for example, the predicted latent state of objects in the scene 104 (e.g., positions, angles, velocities) at time t+1. The image_generation function 508 also takes as input, a variable frames 512. The variable frames 512 refers to reference or context frames (e.g., the original video at time t), possibly for background, texture, or object appearance. For example, the variable frames 512 may take as input the plurality of video frames 106 corresponding to time steps 0 to F shown in FIG. 4B. Thus, as shown in the code snippet 504, the variable future_frames 506 leads to generation of images representing what the scene 104 will look like at a future time step based on the provided state and visual context. This is repeated for each of the future time steps, such as the time steps F+1 through T depicted in FIG. 4B.

In an embodiment, the rendering program 212 is configured to generate the set of predicted video frames 418 based on estimated or simulated future states of objects, which is the predicted latent states 406, within the scene 104. The generated frames may be used for visual foresight, simulation visualization, or as a supervisory signal for refining perception and dynamics models. This enables the system 102 to produce interpretable visual outputs aligned with its internal physical predictions.

To that end, the rendering program 212 is configured to map the predicted latent states 406 back to the visual domain, producing RGB frames in the form of the set of the predicted video frames 418 that visualize the predicted outcome. Thus, the full inference pipeline of operation of the system 102—from perception to physics-based latent transformation, to rendering—forms a coherent and interpretable framework for the video prediction task performed by the system 102.

In an embodiment, the rendering program 212, maps the predicted latent states

$$( {\{ {s}_{i} \}}_{i = F + 1}^{T} )$$

back to the RGB-frames. Thus, the full interference pipeline of operation of the system 102 includes having [symbol] derive the state-representation of the seen frames in a video

$$( {\{ {f}_{i} \}}_{i = 0}^{F} ) ,$$

followed by [symbol] forecasting the set of neuro-symbolic states corresponding to the unseen frames

$$( {\{ {s}_{i} \}}_{i = F + 1}^{T} ) ,$$

given the state-representation of the seen frames in the video

$$( {\{ {s}_{i} \}}_{i = 0}^{F} ) .$$

Finally, [symbol] decodes the predicted states, corresponding to the unseen frames, in order to synthesize the predictions for the corresponding RGB-frames

$$( {\{ \hat{{f}_{i}} \}}_{i = F + 1}^{T} ) .$$

In some embodiments, the system 102 is configured for learning physical laws in the latent space, and transforming states, accordingly, causing bridging of the gap between neural perception and symbolic reasoning. This fusion provides a principled and effective way to predict future events, generate alternative scenarios, and explain system behavior—all from a minimal number of training examples.

In some embodiments, the rendering program 212, [symbol] , uses a physics-based simulator to generate the predicted visual frames from symbolic state information. The [symbol] program is responsible for mapping the states of the predicted frames to the RGB-domain, using a physics-based simulator.

In some embodiments, the system 102 leverages the effective program generation capacity of Large Language/Large Vision-Language Models (LLM/VLM) to propose hypotheses for [symbol] , [symbol] , and [symbol] , given the frames of a training video, f_{0:T}. To aid the VLM in this search, Affordance Rules (ARLs) may be designed which describe certain constraints governing the dynamics of the environment to aid the simulation of the dynamics in the pixel space. For instance, the ARL for a rigid body motion environment setting could be that the affine transforms capture the motion of a rigid object in the RGB-frame. This significantly reduces the number of candidate hypotheses programs which fit the training data, thereby making the searching task by the LLM/VLM, more efficient.

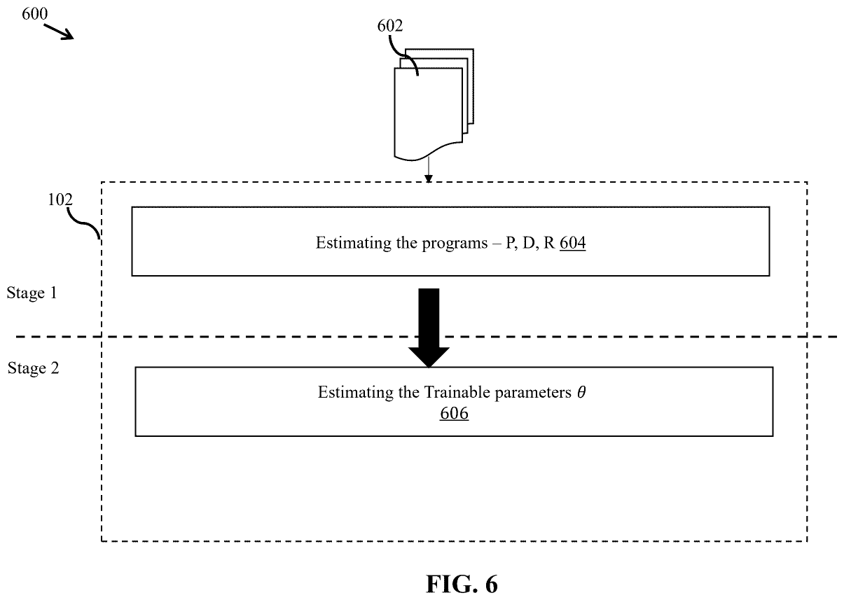

FIG. 6 illustrates a schematic diagram showing the training of the system 102, according to an embodiment of the present disclosure. FIG. 6 is explained in conjunction with elements from the preceding figures FIG. 1, FIG. 2, FIG. 3A, FIG. 3B, FIG. 4A, FIG. 4B and FIG. 5.

In some embodiments, the system 102 is trained for the estimation of the three programs—the perception program 208, the dynamics program 210, and the rendering program 212. Further, at inference time, each of the three programs are executed to perform the functionalities described above.

In some embodiments, training of the system 102 includes optimizing continuous parameters, θ, used in the dynamics program 210 using a gradient-based or black-box optimization algorithm. The training of the system 102 may include two stages—a program synthesis training stage for the synthesis pipeline 110, and a parameter optimization training stage for the execution pipeline 112.

In some embodiments, the system 102 is trained for jointly estimating the program structure (P, D, R) and continuous parameters (0) that govern the behavior of D and possibly P or R. The training objective maximizes the likelihood of observed frame sequences across a set of videos, either by minimizing a pixel-wise reconstruction loss or a surrogate loss based on semantically-relevant state variables. To improve interpretability and modularity, the program components are synthesized using foundation models (e.g., large language or vision-language models), with continuous parameters treated as optimizable placeholders with respect to training data comprising ground-truth video frames. A two-stage optimization process is employed: program structure is inferred first, followed by numerical optimization of θ using gradient-based or black-box techniques depending on program differentiability. This enables the system 102 to combine symbolic reasoning with continuous control for video forecasting, simulation, and scene understanding. Using the training methodologies disclosed above, the system 102 is trained with fewer than 100 example videos while achieving generalizable frame prediction performance. This is explained further in the following description.

In some embodiments, the system 102 is trained to estimate the programs [symbol] , [symbol] , and [symbol] for N training videos 602. The system 102 is also used to estimate a handful of the global parameters θ in order to maximize the likelihood of the frames in each of the N training videos 602. For each video, this can be captured by the following probabilistic formulation:

$$ℒ ( {f}_{0 : T} ; 𝒫 , 𝒟 , θ , ℛ ) := p ( {f}_{0 : T} \vert {s}_{0} ; 𝒫 , 𝒟 , θ , ℛ ) = {\int }_{{s}_{0 : T}} p ( {f}_{T} \vert {f}_{0 : T - 1} , {s}_{0} ; 𝒫 , 𝒟 , θ , ℛ ) p ( {f}_{0 : T - 1} \vert {s}_{0} ; 𝒫 , 𝒟 , θ , ℛ ) d {s}_{t} = {\int }_{{s}_{0 : T}} p ( {f}_{t} \vert {s}_{t} ) p ( {s}_{t} \vert {s}_{t - 1} ) p ( {s}_{t - 1} \vert {f}_{0 : t - 1} ) p ( {f}_{0 : t - 1} \vert {s}_{0} ; 𝒫 , 𝒟 , θ , ℛ ) d {s}_{t} = {\int }_{{s}_{1 : T}} {\prod }_{t = 1}^{T} r ( {f}_{t} \vert {s}_{t} ; ℛ ) h ( {s}_{t} \vert {s}_{t - 1} ; 𝒟 , θ ) p ( {s}_{t - 1} \vert {f}_{t - 1} ; 𝒫 ) {ds}_{t}$$

The training objective may then be represented as follows:

$$𝒫 , 𝒟 , θ , ℛ = arg {max}_{\tilde{𝒫} , \tilde{𝒟} , θ , \tilde{ℛ}} ℒ ( {f}_{0 : T} ; \tilde{𝒫} , \tilde{𝒟} , θ , \tilde{ℛ} )$$

In order to aid interpretability and for ease of design, it may be assumed that r(fₜ|sₜ; [symbol] )~ [symbol] (fₜ, Σ), where Σ is an isotropic constant. Since maximizing the likelihood is equivalent to maximizing its logarithmic variant, this results in the following optimization setup, over the training set:

$$log ℒ ( {f}_{0 : T} ; 𝒫 , 𝒟 , θ , ℛ ) ∝ {\sum }_{i = 1}^{N} {\sum }_{t = 0}^{T} {‖ {\hat{f}}_{t}^{i} - {f}_{t}^{i} ‖}^{2} , \qquad ( 2 )$$

where

$${\hat{f}}_{t}^{i}$$

denotes the estimate of the t^{th}-frame by ProgGen (the proposed method) of the i^{th} video while fₜ denotes the true frame in the training video.

In some embodiments, the training of the system 102 includes two-stage training optimization pipeline. The foundation model 206 is configured to synthesize programs and analyze the discrete structures of the scene 104. The two-stage training optimization pipeline includes—(i) In the first stage 604, estimating the programs, [symbol] , [symbol] , and [symbol] , and (ii) In the second stage 606, estimating the trainable continuous parameters θ. To enable the learning of the continuous parameters, the LLMs are prompted to synthesize programs with placeholders for the continuous parameters, θ: prog~q_{LLM}(⋅|f_{0:T}). The continuous parameters are then learned by maximizing the likelihood of the seen frames of a given video in the N training videos 602, as shown in Eq. 1. For non-differentiable programs, black-box optimizers such as the Powell's method may be used to learn the parameters. If the Affordance Rules requires LLMs/VLMs to generate differentiable programs, e.g., using JAX, then higher-order optimizers such as L-BFGS are used for more efficient optimization. These optimizations are executed till convergence or until a maximum number of iterations, whichever occurs earlier.

In some embodiments, the system 102 is trained using the typical pixel-level training loss, shown in Eq. 2. The pixel-level training loss, while being differentiable and easy to optimize is not sensitive to the accuracy of the reconstructed frames, such as the predicted video frames 418. For instance, if in a scene a large, white background occupies most of the pixels, Eq. 2 yields a low loss even if the reconstructed foreground is inaccurate. Moreover, the computational cost to run [symbol] for every frame in a training video, for each of the N training videos 602 is expensive. As a fix to this, independent estimation of the attributes, such as those corresponding to the latent state representations 306, may be done for defining the state of the training video. Such attributes could include positions of objects, angles, etc. and could be independently estimated using tools such as Segment Anything Model (SAM) and appropriate functions from OpenCV. Like Eq. 2, the likelihood estimation task for each training set video, then becomes:

$$ℒ ( {s}_{0 : T} ; 𝒫 , 𝒟 , θ ) := q ( {s}_{0 : T} \vert {f}_{0 : T} ; 𝒫 , 𝒟 , θ ) \qquad ( 3 )$$

$$∝ {\sum }_{t = 0}^{T} {‖ {\hat{s}}_{t} - {s}_{t} ‖}^{2} , \qquad ( 4 )$$

where ŝₜ denotes the estimate of the t^{th}-state while sₜ denotes the true state value.

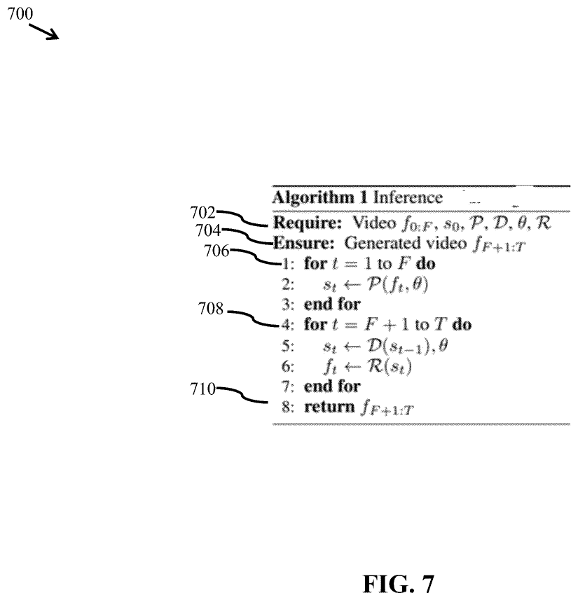

The trained system 102 is then used to execute the execution pipeline 112 according to an algorithm for inference, as disclosed in FIG. 7.

FIG. 7 illustrates a schematic diagram showing an inference algorithm 700 executed by the system 102 during an inference time, according to an embodiment of the present disclosure. FIG. 7 is explained in conjunction with elements from FIG. 1, FIG. 2, FIG. 3A, FIG. 3B, FIG. 4A, FIG. 4B, FIG. 5, and FIG. 6.

In an embodiment, the inference algorithm 700 is executed by the processor 204 during execution of the method 100. The inference algorithm 700 begins with reception 702 of: a video f_{0:F}, s₀, [symbol] , [symbol] , θ, [symbol] .

At 704, the future frames of a video f_{F+1:T} is generated. Next, a for loop 706 is executed from t=1 to F to perform the operation sₜ← [symbol] (fₜ,θ).

After completion of the for loop 706, another for loop 708 is executed for t=F+1 to T to perform the operation sₜ← [symbol] (sₜ₋₁), θfₜ← [symbol] (sₜ).

In the end, at the output of the inference algorithm a return operation 710 is executed to output the predicted video frames f_{F+1:T} (equivalent to the predicted video frames 418).

The inference algorithm 700 provides a programmatic reasoning pipeline that offers: (i) an algorithmic way of generating the future (unseen) frames which does away with the need for inference on models which need copious amounts of in-domain training data; and (ii) near-complete interpretability for every step of the inference process. Further, the inference algorithm 700 enables predictive video generation by decomposing the task of video prediction into interpretable modular subprograms, facilitating integration with learned dynamics and symbolic scene representations.

The system 102 configured with training and inference methodologies described above performs accurately and less prone to error video prediction. The system 102 marks a change in basic assumptions in video prediction. It steps away from the black-box paradigm of deep learning and toward a symbolic, interpretable, and adaptive AI, blending the flexibility of neural networks with the precision of programmatic reasoning. Its capacity to predict, explain, and simulate future events from minimal data makes it a compelling foundation for next-generation AI systems that must operate in open-ended, dynamic, and safety-sensitive environments.

The broader implication of the performance of the system 102 is the validation of hybrid AI systems that synthesize traditional symbolic reasoning with modern deep learning. By aligning machine perception with human-like abstractions and using large models as hypothesis generators rather than end-to-end predictors, the system 102 offers a scalable, efficient, and transparent approach to a classically difficult problem. This not only advances the field of video prediction but also demonstrates a path forward for building AI systems that are both smart and understandable.

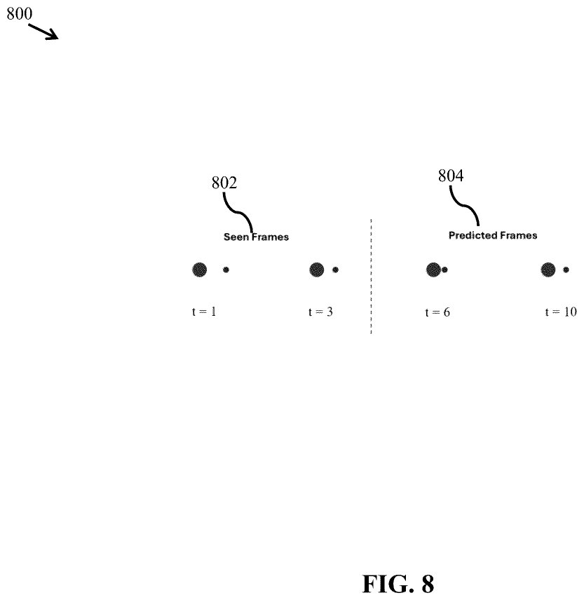

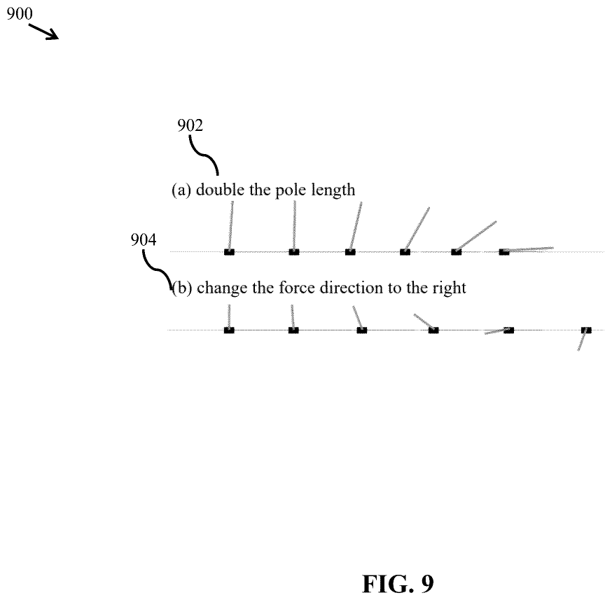

The performance of the system 102 is elaborated further with the help of evaluation examples disclosed in FIG. 8 and FIG. 9.

FIG. 8 illustrates a schematic diagram showing a qualitative visualization 800 for frames predicted by the system 102 for Phyworld out of domain (OOD) two ball collision case, according to an embodiment of the present disclosure.

The Phyworld environment shown in the visualization 800 simulates the kinematic states for various physical scenarios, such as with two balls moving in a confined space and/or colliding with each other. The visualization shows limited number of seen frames 802, from t=1 to t=3, which are used to generate predicted frames 804, from t=4 to t=10.

In some embodiments, experiments are conducted, and videos are collected from this environment under two settings: (i) Uniform: Here there is only one ball that moves horizontally with a constant velocity in the space. The law of inertia guides the motion of the ball; (ii) Collision: Here there are two balls of different sizes (i.e., radii), moving horizontally at different velocities and colliding with each other. The law of conservation of energy and momentum guides the collision process and the velocities after the collision. In some embodiments, videos are generated under the aforementioned settings by varying the radii and the velocities of the balls. The system 102 may be configured for estimating the positions of the ball to define the states. In an example, the videos contain a total of 20 frames, with the first 3 frames being used for conditioning (i.e., seen frames). To assess the generalizability of the system 102, evaluations are conducted under two settings: (i) In-distribution: Here the videos in the test set have ball velocities similar to those in the training; (ii) Out-of-distribution: Here the videos contain ball velocities much higher than those in the training set.

In some embodiments, all baseline models are trained with varying training set sizes, viz. 30k and 3M videos under the aforementioned settings. For the system 102, on the other hand, only 10 videos are used to train for the parameters, θ.

In some embodiments, an error measure is used, based on the estimated velocities of the one or more balls, in every frame, when compared to that used for the synthesis of the videos to assess the quality of prediction. The per-frame velocity is computed as:

$${v}_{t}^{i} = {x}_{t}^{i} - {x}_{t - 1}^{i} ; ∀ t ∈ \{ F + 1 , … , T \} , ∀ i ∈ \{ 1 , … , B \}$$

where

$${v}_{t}^{i}$$

is the velocity of the i^{th} ball in the t^{th} frame, while

$${x}_{t}^{i}$$

denotes the pixel location of the center of the ball in the t^{th} frame and B is the total number of balls in the environment. The final performance measure is an average of this error over all the balls.

During evaluation, the system 102 significantly outperforms the state-of-the-art diffusion models (i.e., DIT-small, DIT-big, DIT-large), trained on 30k training videos, even though the system 102 is only trained on 10 videos. In particular, the velocity error measures for the system 102 are an order of magnitude smaller for the out-of-distribution (ood) case when compared to the diffusion-based baseline models. Further, even when the diffusion models are trained with 100×the number of training videos, i.e., 3M, the system 102 still performs comparably. To that end, the flexibility obtained by the system 102 in modeling the video prediction task programmatically helps in capturing the dynamics of the video at the semantic level, i.e., in describing the world model in terms of objects and their motion rather than in terms of changes at the pixel level. Additionally, the global parameters θ accommodate for variance within the type of motion structure captured in the programs allowing the system 102 to fit to a wide range of videos.

FIG. 9 illustrates a schematic diagram showing a qualitative visualization 900 for frames predicted by the system 102 for the Cart Pole case, according to an embodiment of the present disclosure.

The Cart pole environment includes a constant action—pulling a cart to the left, while the pole rotates in a clockwise direction. The visualization shows videos that are generated by altering the pole's initial angle, the velocity of the cart, and the angular velocity of the pole. A programmatic approach to video frame prediction needs to automatically determine that these are the attributes to be estimated and undertake the prediction by extrapolating the dynamics using these attributes. In this setting, the generalizability of competing approaches may also be assessed by adopting a zero-shot setting where there are no training videos and the models are asked to generate the next ten frames of a video, given the first 10 frames.

In some embodiments, the qualities of the generated videos in the Cart Pole environment are evaluated by comparing them with the ground-truth videos using metrics that assess the quality of reconstructed RGB-frames and reporting the mean performance, including mean-absolute error (MAE), PSNR, and LPIPS.

In some embodiments, to assess the generalizability of the system 102, the system 102 was evaluated against competing baselines on the gym-Cart Pole environment. The system 102 outperforms all competing baselines, across all measures, by significant margins in this environment. Further, the system 102 can accommodate counter-factual reasoning effectively, as if the pole length were to be doubled, as shown in a first scenario 902; or the direction of motion of the cart were to be reversed, as shown in a second scenario 904; and still generate plausible frames.

Based on the evaluation of the system 102 in the examples disclosed in FIG. 8 and FIG. 9, it may be observed that the system 102 provides a synthetic approach to video frame prediction which relies on the inductive biases of LLM/VLM to construct world models of videos, represented as a sequence of neuro-symbolic, human-interpretable states. The system 102, while still largely modeling the video in an object-centric fashion, can outperform state-of-the-art diffusion models for the task across multiple challenging environments, while utilizing only a fraction of the training data.

In some embodiments, the system 102 also provides an intuitive and editable interface for optimizing video prediction according to user preferences. This is illustrated in FIG. 10 and FIG. 11.

FIG. 10 illustrates a schematic diagram 1000 of a user interface 1002 for the system 102, in accordance with an embodiment of the present disclosure.

The user interface 1002 includes a prompt input box 1004, a submit icon 1008, and a voice input icon 1010.

The prompt input box 1004 may be used to enter a prompt 1006 to specify user preferences. For example, the prompt 1006 is used to generate the dynamics program 210 [symbol] , using a VLM, for the Cart Pole environment: “The environment you're in is the classic Cart Pole environment. This is a well-known problem in reinforcement learning where a pole is attached by an un-actuated joint to a cart, which moves along a frictionless track. The goal is to keep the pole upright by moving the cart left or right. The state of the system is represented by a tuple consisting of 1. cart_position: The position of the cart on the track. 2. cart_velocity: The velocity of the cart. 3. pole_angle: The angle of the pole with the vertical axis. 4. pole_angular_velocity: The angular velocity of the pole. Given this setup, the dynamics of the environment are governed by the physics of the system, specifically the equations of motion for the cart and the pole. The force applied to the cart (left or right) will affect these state variables over time. We'll use some constants (which will be optimized later) such as gravity, mass of the cart and pole, length of the pole, and the time step for the discretization of the dynamics.”

The above prompt leads to the synthesized program illustrated in the user interface shown in FIG. 11.

FIG. 11 illustrates a schematic diagram 1100 showing an example user interface 1102 showing a synthesized program 1104. The synthesized program 1104 includes for example, “def transition (state: jnp.ndarray, params: jnp.ndarray): x, x_dot, theta, theta_dot=state mass_cart, mass_pole, length, force=params[:4] total_mass=mass_cart+mass_pole cos_theta, sin_theta=jnp.cos(theta), jnp.sin(theta) temp=(force+pole_mass_length*theta_dot**2* sin_theta)/total_mass_theta_acc=(gravity*sin_theta−cos_theta*temp)/(length*(4.0/3.0−mass_pole*cos_theta**2/total_mass)) x_acc=temp−pole_mass_length*theta_acc*cos_theta/total_mass x=x+time_step*x_dot x_dot=x_dot+time_step*x_acc theta=theta+time_step*theta_dot theta_dot=theta_dot+time_step*theta_acc return jnp.array([x, x_dot, theta, theta_dot])”.

The synthesized program 1104 may be used by the user of the system 102 or may be further optimized by entering more user preferences and customizations in a subsequent prompt input interface 1106.

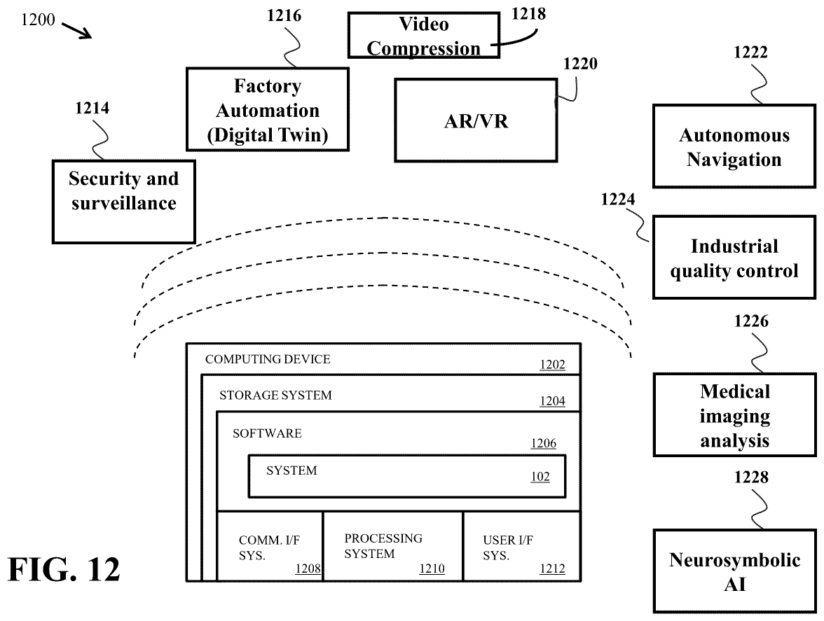

The user interfaces depicted in FIG. 10 and FIG. 11 may be implemented on a computing device, such as illustrated in FIG. 12.

FIG. 12 illustrates a block diagram 1200 of a computing device 1202 that is representative of any system or collection of systems in which the various processes, programs, services, and scenarios disclosed herein may be implemented. The computing device 1202 is used to implement and/or embody the functionalities and operations performed by the system 102.

Examples of the computing device 1202 include, but are not limited to, desktop and laptop computers, tablet computers, mobile computers, audio devices, and wearable devices. Examples may also include server computers, web servers, cloud computing platforms, and data center equipment, as well as any other type of physical or virtual server machine, container, and any variation or combination thereof.

The computing device 1202 may be implemented as a single apparatus, system, or device or may be implemented in a distributed manner as multiple apparatuses, systems, or devices. The computing device 1202 includes, but is not limited to, processing system 1210, storage system 1204, software 1206, communication interface system 1208, and user interface system 1212. Processing system 1210 is operatively coupled with storage system 1204, communication interface system 1208, and user interface system 1212.

Processing system 1210 loads and executes software 1206 from storage system 1204. Software 1206 includes and implements the foundation model 206 which is configured for generating the perception program 208, the dynamics program 210, and the rendering program 212. When executed by the processing system 1210, software 1206 directs processing system 1210 to operate as described herein for at least the various processes, operational scenarios, and sequences discussed in the foregoing implementations. Processing system 1210 executes the generated programs—the perception program 208, the dynamics program 210, and the rendering program 212. Computing device 1202 may optionally include additional devices, features, or functionality not discussed for purposes of brevity.

Referring still to FIG. 12, processing system 1210 may comprise a micro-processor and other circuitry that retrieves and executes software 1206 from storage system 1204. Processing system 1210 may be implemented within a single processing device but may also be distributed across multiple processing devices or sub-systems that cooperate in executing program instructions. Examples of processing system 1210 include general purpose central processing units, graphical processing units, digital signal processors, application specific processors, and logic devices, as well as any other type of processing device, combinations, or variations thereof.

Storage system 1204 may comprise any computer readable storage media readable by processing system 1310 and capable of storing software 1206. Storage system 1204 may include volatile and nonvolatile, removable, and non-removable media implemented in any method or technology for storage of information, such as computer readable instructions, data structures, program modules, or other data. Examples of storage system 1204 include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1204 may also include computer readable communication media over which at least some of the software 1206 may be communicated internally or externally. Storage system 1204 may be implemented as a single storage device but may also be implemented across multiple storage devices or sub-systems co-located or distributed relative to each other. Storage system 1204 may comprise additional elements, such as a controller, capable of communicating with processing system 1210 or possibly other systems.

Software 1206 includes the system 102 which further includes the foundation model 206, the perception program 208, the dynamics program 210, and the rendering program 212. Each component of the system 102 may be implemented in program instructions and among other functions may, when executed by the processing system 1210, direct processing system 1210 to operate as described with respect to the various operational scenarios, sequences, and processes illustrated herein. For example, software 1206 may include program instructions for implementing the inference and training processes described herein.

In particular, the program instructions may include various components or modules that cooperate or otherwise interact to conduct the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1206 may include additional processes, programs, or components, such as operating system software, virtualization software, or other application software. Software 1206 may also comprise firmware or some other form of machine-readable processing instructions executable by processing system 1210.

In general, software 1206 may, when loaded into processing system 1210 and executed, transform a suitable apparatus, system, or device (of which computing device 1202 is representative) overall from a general-purpose computing system into a special-purpose computing system customized to perform inference and/or training operations performed by the system 102 in various embodiments disclosed above, in an optimized manner. Indeed, encoding software 1206 on storage system 1204 may transform the physical structure of storage system 1204. The specific transformation of the physical structure may depend on various factors in different implementations of this description. Examples of such factors may include, but are not limited to, the technology used to implement the storage media of storage system 1204 and whether the computer-storage media are characterized as primary or secondary storage, as well as other factors.

For example, if the computer readable storage media are implemented as semiconductor-based memory, software 1206 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1208 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1202 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The computing device 1202 shown in FIG. 12 can control a variety of exemplar systems by leveraging the principles of programmatic video prediction disclosed in various embodiments described above. Exemplar systems, in embodiments, which are effectively controlled by the computing device 1202, include, but are not limited to, security and surveillance 1214, factory automation 1216, video compression 1218, AR/VR applications 1220, autonomous navigation 1222, industrial quality control 1224, medical imaging analysis 1226, and neuro-symbolic AI 1228.

Programmatic video prediction performed by the system 102 may be used for various security and surveillance 1214 applications to anticipate future video states based on observed behavior. By comparing predicted frame sequences against live video streams, the system identifies deviations indicative of anomalous or suspicious activity. Such predictive surveillance enables pre-incident intervention and enhances situational awareness in security-critical environments.

In an embodiment, the video frame prediction performed by the system 102 is employed in factory automation 1216 systems to anticipate future states of machinery, conveyor lines, or robotic operations based on real-time visual input. The system 102 utilizes the perception program 208 and the dynamics program 210 to extract symbolic, physics-grounded attributes (e.g., position, velocity, tool trajectory) from a sequence of video frames, and to simulate the temporal evolution of such attributes. The predicted future video frames are compared with expected operational states to detect anomalies, inefficiencies, or potential failures before they occur. In some embodiments, the system 102 with a digital twin of the manufacturing environment, wherein the digital twin is continuously updated with predicted visual and physical states to enable initiative-taking control, maintenance scheduling, and optimization of production workflows. For example, the system 102 may predict that a robotic arm will collide with a misaligned workpiece three frames ahead, prompting a corrective signal to a controller to halt or reroute the operation in real time.

In an embodiment, the video frame prediction performed by the system 102 is employed in video compression 1218 systems to reduce bandwidth and storage requirements by predicting future frames from preceding ones using the functionality of the foundation model 206. The system 102 comprises the perception program 208 configured to extract symbolic, interpretable attributes from input video frames, the dynamics program 210 that models the temporal evolution of such attributes, and the rendering program 212 that synthesizes predicted video frames. Rather than encoding each frame independently, the system 102 transmits a subset of key frames along with compact latent representations or residual errors between predicted and actual frames. This enables efficient reconstruction of intermediate frames at the decoder side. Thus, the system 102 provides prediction-driven approach for video compression 1218 and enables lower bitrates and improved compression efficiency without significant loss of visual quality, particularly in scenes with structured or repetitive motion such as surveillance footage, traffic videos, or automated factory floor recordings.

In an embodiment, the system 102 is employed in an augmented reality (AR) or virtual reality (VR), i.e., AR/VR 1220 environment to enable real-time, anticipatory rendering and latency compensation. The system 102 includes the perception program 208 that is configured to extract symbolic, human-interpretable, and physics-grounded attributes—such as user gaze direction, hand motion, head orientation, and object positions—from a sequence of input video frames. The dynamics program 210 models the temporal evolution of these extracted attributes based on learned physical and behavioral principles, allowing the system 102 to anticipate future scene states and user interactions. By predicting future visual frames corresponding to these anticipated states, the system 102 enables early rendering of content, reducing perceived latency and enhancing responsiveness in immersive experiences. The perception program 208 contributes by providing interpretable and adaptive input representations, while the dynamics program 210 enhances continuity and realism by predicting smooth, physics-consistent transitions. For example, the system 102 may predict a user's hand reaching for a virtual object 100 milliseconds in advance, allowing the system 102 to render the resulting interaction frame ahead of time, thereby improving immersion and interactivity.

In an embodiment, the system 102 is integrated into an autonomous navigation platform 1222 to enable anticipatory decision-making and enhance situational awareness. To that end, the perception program 208 is configured to extract symbolic and physics-grounded attributes—such as positions, velocities, trajectories, and object types—from a series of video frames captured by onboard sensors. The dynamics program 210 models the temporal evolution of these attributes based on physical interaction rules and motion patterns, thereby forecasting future states of the environment. The system 102 utilizes these predictions to generate future video frames depicting likely scenes that the autonomous agent (e.g., vehicle, drone, or robot) may encounter. This predictive capability allows the autonomous navigation platform 1222 to proactively plan maneuvers, avoid collisions, and adapt to dynamic environments. The perception program 208 provides structured and interpretable scene understanding, while the dynamics program 210 enables robust forecasting of complex, multi-agent interactions. For example, the system 102 may predict that a pedestrian will enter a crosswalk in 1.5 seconds based on current trajectory cues, allowing the autonomous vehicle to initiate deceleration ahead of time, thus improving safety and decision latency.

In an embodiment, the system 102 is deployed in the industrial quality control 1224 environment to monitor production processes and detect potential defects in real time. The system 102 includes the perception program 208 that is configured to extract symbolic, human-interpretable, and physics-grounded attributes—such as object alignment, motion trajectory, part dimensions, or surface consistency—from a sequence of production line video frames. The dynamics program 210 models the expected temporal evolution of these attributes under nominal operating conditions. By predicting future video frames representing how the manufactured item or process should evolve, the system 102 enables early identification of deviations from expected behavior. This predictive approach facilitates initiative-taking defect detection, reduced inspection latency, and minimized material waste. The perception program 208 enhances interpretability and adaptability across varying products, while the dynamics program 210 provides physics-consistent forecasts that reveal subtle anomalies. For example, if the system 102 predicts that a component on a conveyor should rotate 90 degrees before assembly but observes a deviation in rotation angle, it may flag the part for removal before it reaches the next stage, ensuring production quality and efficiency.

In an embodiment, a video frame prediction system is applied in the domain of medical imaging and analysis to enable anticipatory visualization, temporal anomaly detection, and motion-compensated diagnostics. The system includes a perception program configured to extract symbolic, physics-grounded attributes—such as organ boundaries, tissue deformation patterns, or flow velocities—from temporally sequenced medical image frames (e.g., ultrasound, fluoroscopy, or endoscopy). A dynamics program models the temporal evolution of these attributes according to physiological principles, enabling prediction of future anatomical states. By generating predicted future frames that represent the expected progression of biological structures or processes, the system assists clinicians in identifying deviations indicative of abnormalities, enhances image-guided procedures, and supports motion-compensated reconstruction. The perception program 208 contributes to robust, interpretable representations of complex anatomy, while the dynamics program 210 ensures continuity with underlying physiological behavior. For instance, during a cardiac ultrasound, the system 102 may predict the next contraction phase of the heart based on prior motion, allowing automated detection of arrhythmias or impaired valve function in real time. The rendering program 212 renders this visualization on a display associated with the computing device 1202 for pre-operative, post-operative or during operation procedures.

In some embodiments, the system 102 is configured for neuro-symbolic AI 1228 applications, specifically based on counterfactual reasoning. To that end, neuro-symbolic AI 1228 may be a reasoning paradigm which is used as a basis of all the applications of the system 102, such as those depicted in FIG. 12 and the like. Counterfactual reasoning involves modifying part of the input or condition, and predicting the hypothetical output, not seen during training. To that end, in an embodiment, the system 102 is implemented within a neuro-symbolic AI framework to enable interpretable and physically grounded temporal reasoning over visual data. The perception program 208 extracts symbolic representations—such as object identity, spatial relationships, and physical attributes (e.g., velocity, mass, contact status) from raw video frames using neural modules trained to align with structured symbolic vocabularies. The dynamics program 210 then models the logical and physical evolution of these symbolic attributes over time, enabling prediction of future states through rule-guided inference. The predicted future video frames, synthesized via the rendering program 212, serve as evidence for downstream tasks such as causal inference, counterfactual simulation, and commonsense reasoning. The perception program 208 grounds high-dimensional visual inputs in a structured, interpretable latent space, while the dynamics program introduces rule-consistent, generalizable predictions. For example, the system 102 may infer that a falling object will land behind a wall and disappear from view, allowing it to explain this occlusion in symbolic terms and simulate alternative outcomes under modified initial conditions enabling counterfactual reasoning in robotics, virtual agents, or decision-support systems.

For example, in the autonomous driving domain, the system 102 can be used to simulate vehicle and pedestrian trajectories based on limited visual input, while providing interpretable descriptions of how those predictions arise. This allows for greater trust and safety auditing in complex, dynamic environments. Similarly, in robotics, a robot could use the system 102 to simulate the outcomes of various manipulation strategies, choosing the one that aligns best with its goals while adapting on-the-fly to novel objects or scenarios. In video surveillance, the system 102 enables systems to predict human movements in public spaces, allowing for initiative-taking safety interventions without requiring a massive amount of training data.

In the educational or scientific visualization space, the system 102 opens new doors for interactive tools where students or researchers can modify physical parameters in a visual simulation and observe the outcomes—much like a sandbox physics engine, but one that learns and adapts from a few examples. Furthermore, content creators could use the system 102 to generate consistent visual animations from sketches of motion or from textual prompts, bringing creative ideas to life in a controllable way.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching disclosure principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the disclosure is not limited to the specific embodiments described above, but only by the claims and their equivalents.

1. A computer-implemented method for video frame prediction, comprising:
receiving a plurality of video frames representing an initial portion of a scene;
generating, via a foundation model, a perception program configured to extract attributes from each of the plurality of received video frames;
generating, via the foundation model, a dynamics program that models the temporal evolution of the extracted attributes based on physical principles;
generating, via the foundation model, a rendering program that maps future attribute states to predicted video frames;
executing the perception program to extract latent state representations from the initial video frames, wherein the latent state representations are derived on the basis of the extracted attributes associated with each of the plurality of video frames;
applying the dynamics program to the latent state representations to generate predicted latent states corresponding to future time steps; and
executing the rendering program to transform the predicted latent states into future video frames to perform the video frame prediction;
wherein the perception program, the dynamics program, and the rendering program are each synthesized in a programmatic, human-interpretable format, and the latent state representations comprise physics-grounded variables.

2. The method of claim 1, wherein the foundation model comprises at least one of a large language model (LLM) and a vision language model (VLM).

3. The method of claim 1, wherein the perception program utilizes a pre-trained object segmentation model to identify objects within the plurality of video frames.

4. The method of claim 1, wherein the dynamics program comprises symbolic code that encodes physical laws.

5. The method of claim 1, further comprising:
receiving a user-specified modification to a latent state variable associated with the latent state representations; and
applying, the dynamics program and the rendering program, to generate a counterfactual video prediction corresponding to the user-specified modification to the latent state variable associated with the latent state representations.

6. The method of claim 1, wherein the foundation model is prompted with natural language instructions that describe the environment depicted in the plurality of video frames to guide synthesis of the dynamics program.

7. The method of claim 1, wherein the rendering program uses a physics-based simulator to generate the future video frames from the predicted latent states.

8. The method of claim 1, wherein the latent space is structured such that transformations of the latent states preserve physical consistency across time steps.

9. The method of claim 1, further comprising optimizing continuous parameters used in the dynamics program using a gradient-based optimization algorithm or a black-box optimization algorithm.

10. The method of claim 1, wherein the perception program, the dynamics program, and the rendering program comprise placeholder parameters to be optimized with respect to training data comprising ground-truth video frames.

11. The method of claim 1, further comprising executing a training operation with fewer than 100 example videos.

12. The method of claim 1, wherein the physics-grounded variables comprise at least one of position, velocity, mass, angle, or force.

13. A system for video frame prediction, comprising:
a processor; and
a memory having instructions stored thereon that, when executed by the processor, cause the system to:
receive a plurality of video frames representing an initial portion of a scene;
generate, via a foundation model, a perception program configured to extract attributes from each of the plurality of received video frames;
generate, via the foundation model, a dynamics program that models the temporal evolution of the extracted attributes based on physical principles;
generate, via the foundation model, a rendering program that maps future attribute states to predicted video frames;
execute the perception program to extract latent state representations from the initial video frames, wherein the latent state representations are derived on the basis of the extracted attributes associated with each of the plurality of video frames;
apply the dynamics program to the latent state representations to generate predicted latent states corresponding to future time steps; and
execute the rendering program to transform the predicted latent states into future video frames to perform the video prediction;
wherein the perception program, the dynamics program, and the rendering program are each synthesized in a programmatic, human-interpretable format, and the latent state representations comprise physics-grounded variables.

14. The system of claim 13, wherein the perception program utilizes a pre-trained object segmentation model to identify objects within the video frames.

15. The system of claim 13, wherein the dynamics program comprises symbolic code that encodes physical laws.

16. The system of claim 13, wherein the processor is further configured to:
receive a user-specified modification to a latent state variable, and
apply, the dynamics program and the rendering program, to generate a counterfactual video prediction corresponding to the modified latent state.

17. The system of claim 13, wherein the foundation model is prompted with natural language instructions that describe the environment depicted in the plurality of video frames to guide synthesis of the dynamics program.

18. The system of claim 13, wherein the rendering program uses a physics-based simulator to generate the future video frames from the predicted latent states.

19. The system of claim 13, wherein the latent space is structured such that transformations of latent states preserve physical consistency across time steps.

20. A non-transitory computer-readable storage medium embodied thereon a program executable by a processor for performing a method for video frame prediction, the method comprising:
receiving a plurality of video frames representing an initial portion of a scene;
generating, via a foundation model, a perception program configured to extract attributes from each of the plurality of received video frames;
generating, via the foundation model, a dynamics program that models the temporal evolution of the extracted attributes based on physical principles;
generating, via the foundation model, a rendering program that maps future attribute states to predicted video frames;
executing the perception program to extract latent state representations from the initial video frames, wherein the latent state representations are derived on the basis of the extracted attributes associated with each of the plurality of video frames;
applying the dynamics program to the latent state representations to generate predicted latent states corresponding to future time steps; and
executing the rendering program to transform the predicted latent states into future video frames to perform the video frame prediction;
wherein the perception program, dynamics program, and rendering program are each synthesized in a programmatic, human-interpretable format, and the latent state representations comprise physics-grounded variables.
